(19) United States
(12) Patent Application Publication
(10) Pub. No.: US 2013/0290077 A1
(43) Pub. Date: Oct. 31, 2013

(54) METHOD FOR OFFERING ENERGY PRICING PROGRAMS

(71) Applicants: Hua Fan, Norcross, GA (US); Santhi Annavajjala, Marietta, GA (US)

(72) Inventors: Hua Fan, Norcross, GA (US); Santhi Annavajjala, Marietta, GA (US)

(73) Assignee: General Electric Company, Schenectady, NY (US)

(21) Appl. No.: 13/458,590

(22) Filed: Apr. 27, 2012

(51) Int. Cl. G06Q 30/02

(52) U.S. Cl. 705/14.1

(57) ABSTRACT

A method for offering energy pricing programs to energy consumers is disclosed. Graphical indicators representing the cost reduction and the comfort reduction for each energy pricing program are displayed, allowing the energy consumer to choose between the energy pricing programs.

### BACKGROUND OF THE INVENTION

The subject matter disclosed herein relates to offering energy pricing programs to energy consumers.

In order to encourage energy consumers to reduce their energy demand, especially during peak demand periods, energy utilities offer energy pricing programs that provide financial incentives to the energy consumers if they reduce or eliminate energy consumption during peak demand periods. In many cases, an energy utility may offer the energy consumer the opportunity to choose among several different energy pricing programs. These energy pricing programs have a plurality of parameters that determine the cost reduction that energy consumers may experience if they enroll in a particular energy pricing program.

Some of these energy pricing programs allow the energy utility to directly control (i.e., turn off) energy consumer loads (e.g., air conditioners) during peak demand periods. Other energy pricing programs allow the energy utility to charge different energy prices to those enrolled in the program (e.g., charge higher prices to energy consumers enrolled in the energy pricing program during peak demand periods than customers not enrolled in the program). In exchange for agreeing to these restrictions on energy consumption or the higher pricing during peak demand pricing, the energy utilities offer financial incentives to energy consumers, including payments and cost reductions if they reduce or eliminate energy consumption during peak demand periods.

Given the large number of energy pricing programs to choose from, with each having a plurality of different parameters, many energy consumers find it difficult to understand and then enroll in a particular energy pricing. For example, many energy consumers do not understand the terminology used to describe the energy pricing programs, including the restrictions on energy consumption or the parameters for each program. As a result, evaluating energy pricing programs can be a complex and confusing task for an energy consumer. This can result in the energy consumer deciding not to enroll in any of the offered energy pricing programs, or enrolling in an energy pricing program without a complete understanding of the programs, leading to customer dissatisfaction with the energy utility.

The discussion above is merely provided for general background information and is not intended to be used as an aid in determining the scope of the claimed subject matter.

### BRIEF DESCRIPTION OF THE INVENTION

A method for offering energy pricing programs to energy consumers is disclosed. Graphical indicators representing the cost reduction and the comfort reduction for each energy pricing program are displayed, allowing the energy consumer to choose between the energy pricing programs. An advantage that may be realized by the practice of some of the disclosed embodiments is allowing an energy consumer to more easily understand and then enroll in one or more of the energy pricing programs.

In one embodiment, a method for offering energy pricing programs is disclosed. The method comprises the steps of displaying a user interface screen comprising a display of a first energy pricing program and a second energy pricing program, displaying a first graphical representation of at least one cost reduction value for the first energy pricing program and a second graphical representation of at least one comfort reduction value for the first energy pricing program, and displaying a first graphical representation of at least one cost reduction value for the second energy pricing program and a second graphical representation of at least one comfort reduction value for the second energy pricing program.

In another embodiment, the method comprises the steps of determining at least one cost reduction value for the first energy pricing program and at least one comfort reduction value for the first energy pricing program, determining at least one cost reduction value for the second energy pricing program and at least one comfort reduction value for the second energy pricing program, displaying a user interface screen comprising a display of a first energy pricing program and a second energy pricing program, displaying a first graphical representation of at least one cost reduction value for the first energy pricing program and a second graphical representation of at least one comfort reduction value for the first energy pricing program, and displaying a first graphical representation of at least one cost reduction value for the second energy pricing program and a second graphical representation of at least one comfort reduction value for the second energy pricing program, wherein the color of the first graphical representation of the at least one cost reduction value for the first energy pricing program is based on the at least one cost reduction value, and the color of the second graphical representation of the at least one comfort reduction value for the first energy pricing program is based on the at least one comfort reduction value, and wherein the size of the first graphical representation of the at least one cost reduction value for the first energy pricing program is based on the at least one cost reduction value, and the size of the second graphical representation of the at least one comfort reduction value for the first energy pricing program is based on the at least one comfort reduction value.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is a diagram of an exemplary system for offering energy pricing programs from an energy utility to an energy consumer;

FIG. 2 is an exemplary user interface screen showing the displays of the available energy pricing programs being offered by an energy utility;

FIG. 3 is an exemplary user interface screen illustrating the parameters of an energy pricing program for a first participation period;

FIG. 4 is an exemplary user interface screen illustrating the parameters of an energy pricing program for a second participation period; and

FIG. 5 is an exemplary user interface screen illustrating the parameters of an energy pricing program for a third participation period.

### DETAILED DESCRIPTION OF THE INVENTION

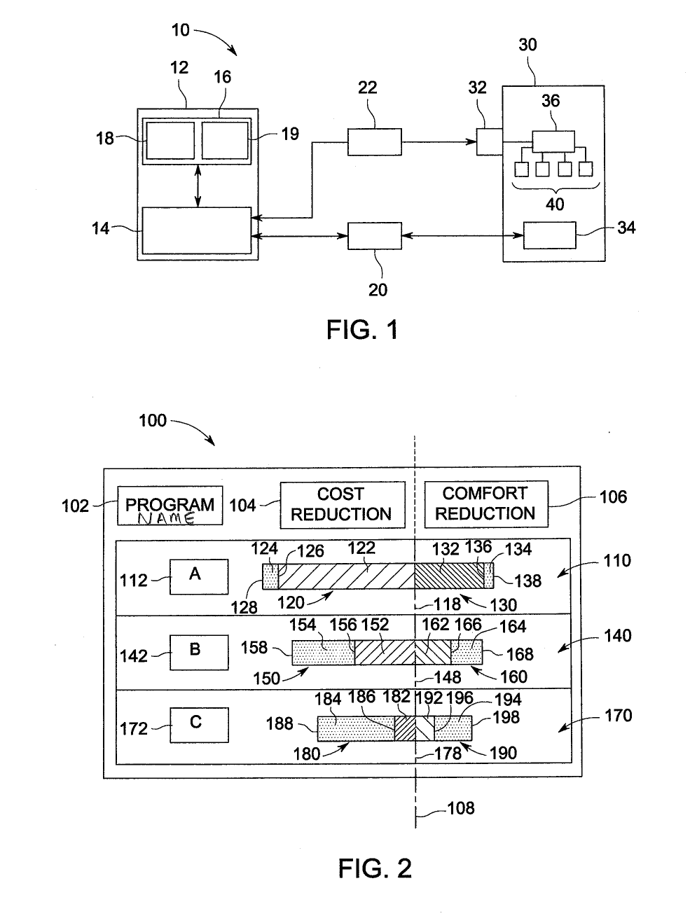

FIG. 1 is a diagram of an exemplary system 10 for offering energy pricing programs from an energy utility 12 to an energy consumer. In one embodiment, an demand management system 14 can communicate with other energy utility management systems 16 over a network, including operation systems 18 (e.g., energy management systems, distribution management systems, outage management systems, etc.) and back office systems 19 (e.g., customer information systems, billing systems, etc.). It will be understood that the demand management system 14 and the management systems 16 can be software located on one or more servers at or remote from the energy utility 10. The servers can have a processor, memory, and executable instructions that are stored on the memory or available to be executed by the processor (e.g., downloadable from a network). These executable instructions can make up all or a portion of the software and software packages discussed herein.

The demand management system 14 can communicate with a web portal 20 over a network (e.g., the Internet). The web portal 20 can communicate with a personal computer (or other electronic device (Smartphone, tablet, etc.)) 34 at the residence 30 of the energy consumer, allowing the energy consumer to access the website of the energy utility 12 and communicate with the demand management system 14 and other management systems 16 of the energy utility 12. The website of the energy utility 12 on the web portal 20 can include a plurality of energy pricing programs offered by the energy utility 12 to the energy consumer.

The demand management system 14 can also communicate with a smart energy meter 32 located at the residence 30 of the energy consumer over an advanced metering infrastructure (AMI) 22. The energy meter 32 can communicate with a smart energy manager 36 that communicates with and monitors the energy being consumed by the smart devices 40 of the energy consumer (e.g., appliances, thermostats, air conditioners, boilers, electronics, vehicle charging stations, etc.). These connections allow the demand management system 14 to monitor and control the smart devices 40 of the energy consumer participating in an energy pricing program.

The energy pricing programs offered by the energy utility 12 to energy consumers through the web portal 20 can have a plurality of parameters. In one embodiment, these energy pricing programs and associated parameters can be provided as inputs to and received by the demand management system 14 from the other energy utility management systems 16. The energy pricing program parameters can include, e.g., program type (PT), annual discount (AD), program start date (PSD), program end date (PED), current date (CD), maximum number of events per year (MEY), maximum number of events per month (MEM), event duration (ED), event start time (EST), event end time (EET), program price (PP), standard price (SP), etc.).

The program type (PT) is the particular demand control strategy employed for that particular energy pricing program (e.g., direct load control, critical peak pricing, time of use pricing, variable peak pricing, and, etc.). For example, under a direct load control (DLC) energy pricing program, the energy utility can directly control (i.e., turn off) energy consumer loads during peak demand periods. Under a critical peak pricing (CPP) energy pricing program, the energy utility can charge higher prices to energy consumers enrolled in the energy pricing program during peak demand periods than customers not enrolled in the program. In exchange for agreeing to these restrictions on energy consumption or the higher pricing during peak demand pricing, the energy utilities offer financial incentives to energy consumers, including payments and cost reductions if they reduce or eliminate energy consumption during peak demand periods. The energy consumer can select an energy pricing program of a particular program type on the web portal 20 and that selection can be communicated as an input to the demand management system 14.

The annual discount (AD) (e.g., $25) is the payment or credit that an energy consumer will receive if they comply with the requirements of the energy pricing program for one year. The program start date (PSD) (e.g., Jan. 1, 2013) is the date on which the program is available to the energy consumer and the program end date (PED) (e.g., Dec. 31, 2013) is the date on which the energy pricing program is no longer available. The current date (CD) (e.g., Feb. 1, 2013) is the current date on or after the program start date (PSD), but before the program end date (PED).

The maximum number of events per year (MEY) (e.g., 60) and the maximum number of events per month (MEM) (e.g., 10) provide the maximum number of peak demand periods that the energy consumer would be required to reduce or eliminate energy consumption pursuant to the terms of the energy program during a particular period (e.g., a year or a month). The event duration (ED) (e.g., two hours) provides the maximum length of time that a particular peak demand period would extend pursuant to the terms of the energy program. The event start time (EST) (e.g., 0) is the hour of the day on a 24 hour cycle that an event would start and the event end time (EET) (e.g., 3) is the hour of the day that an even would end. The start and end time parameters would not be employed for all energy pricing programs (not for direct load control, critical peak pricing, time of use pricing).

The program price (PP) (e.g., $20/kWh) is the higher price that an energy consumer would have to pay for energy consumed during peak demand period or an event as compared to the lower standard price (SP) ($10/kWh) that that an energy user would have to pay for energy consumed outside of peak demand periods or events. These price parameters would not be employed for all energy pricing programs (e.g., not for direct load control programs since energy cannot be consumed during peak demand periods or events when the device is turned off by the energy utility).

These parameters for each energy pricing program determine the cost reduction and the comfort reduction that energy consumers may experience if they enroll in a particular energy pricing program. Understanding not only the cost reduction, but also the comfort reduction associated with a particular energy pricing program, can enable the energy consumer to better understand, compare, and select different energy pricing programs. In the embodiment disclosed herein, graphical indicators representing the cost reduction and the comfort reduction for each energy pricing program are displayed, allowing the energy consumer to more easily understand and then choose between the energy pricing programs. In one embodiment and as will be explained, after selecting a particular energy pricing program, the energy consumer can select the program participation start date (PPSD) and the program participation end date (PPED) and those selections can be communicated as inputs to the demand management system 14.

FIG. 2 is an exemplary user interface screen 100 showing the displays 110, 140, 170 of the available energy pricing programs being offered by an energy utility. The available energy pricing programs user interface screen 100 displays the names (A, B, C) 112, 142, 172 of the energy pricing programs under a program name graphical label 102. The user interface screen 100 also displays a cost reduction graphical indicator 120, 150, 180 (e.g., a bar) for each energy pricing program under a cost reduction graphical label 104, as well as a comfort reduction graphical indicator 130, 160, 190 (e.g., a bar) for each energy pricing program under a comfort reduction graphical label 106. Each of the cost reduction graphical indicators 120, 150, 180 are separated from each of the corresponding comfort reduction graphical indicators 130, 160, 190 for each energy pricing program by centerlines 118, 148, 178 aligned with a centerline 108 separating all of the cost reduction graphical indicators 120, 150, 180 and comfort reduction graphical indicators 130, 160, 190. In one embodiment, the cost reduction graphical indicators 120, 150, 180 and the corresponding comfort reduction graphical indicators 130, 160, 190 for each of the energy pricing programs are horizontally aligned and proximate to each other to allow for easy visual comparison of the relative cost reduction and comfort reduction within each energy pricing program. Similarly, the cost reduction graphical indicators 120, 150, 180 and the corresponding comfort reduction graphical indicators 130, 160, 190 for each of the energy pricing programs are vertically aligned and proximate to each other to allow for easy visual comparison of the relative cost reductions between the energy pricing programs and the relative comfort reductions between the energy pricing programs.

In one embodiment, each of the graphical indicators 120, 130, 150, 160, 180, 190 can use different sizes (e.g., length) and/or colors (e.g., red, yellow, green) to visually represent the differences between the cost reductions and comfort reductions within and between the energy pricing programs. For example, the length of the graphical indicator can represent the relative amount cost reduction or comfort reduction of the energy pricing program, with a longer graphical indicator indicating a higher amount of cost reduction or comfort reduction than a shorter graphical indicator. The length of the graphical indicator can also represent the remaining time for the energy pricing program, with a longer graphical indicator indicating a longer amount of time than a shorter graphical indicator. The color of the graphical indicator for cost reduction can represent the relative amount of cost reduction, with green representing a higher amount of cost reduction (positive connotation), yellow representing a medium amount of cost reduction (neutral connotation), and red representing a lower amount of cost reduction (negative connotation). On the other hand, the color of the graphical indicator for comfort reduction can represent the relative amount of comfort reduction, with red representing a higher amount of comfort reduction (negative connotation), yellow representing a medium amount of comfort reduction (neutral connotation), and green representing a lower amount of comfort reduction (positive connotation).

Referring to FIG. 2, the display 110 of the first energy pricing program (A) includes the first energy pricing program name (A) 112, the first energy pricing program cost reduction graphical indicator 120, the first energy pricing program comfort reduction graphical indicator 130, and the first energy pricing program centerline 118.

The length from the end 128 of the first energy pricing program cost reduction graphical indicator 120 to the first energy pricing program centerline 118 represents the maximum total cost reduction available if an energy consumer were to participate for the entire length of the first energy pricing program. Since, in this example, the energy consumer is reviewing the first energy pricing program after the start of the program and therefore cannot receive the maximum total cost reduction available, the first energy pricing program cost reduction graphical indicator 120 includes a first section 122 representing the maximum remaining cost reduction available, and a second section 124 representing the cost reduction no longer available. The length from the end 126 of the first section 122 to the first energy pricing program centerline 118 represents the maximum remaining cost reduction available if an energy consumer were to participate for the remaining length of the first energy pricing program. In one embodiment, given the relatively long length of the first section 122 representing the maximum remaining cost reduction available for the first energy pricing program, the first section 122 is shown in green. The second section 124 representing the cost reduction no longer available can be shown in a different color (e.g., blue).

The length from the end 138 of the first energy pricing program comfort reduction graphical indicator 130 to the first energy pricing program centerline 118 represents the maximum total comfort reduction possible if an energy consumer were to participate for the entire length of the first energy pricing program. Since, in this example, the energy consumer is reviewing the first energy pricing program after the start of the program and therefore cannot receive the maximum total comfort reduction possible, the first energy pricing program comfort reduction graphical indicator 130 includes a first section 132 representing the maximum remaining comfort reduction possible, and a second section 134 representing the comfort reduction no longer possible. The length from the end 136 of the first section 132 to the first energy pricing program centerline 118 represents the maximum remaining comfort reduction possible if an energy consumer were to participate for the remaining length of the first energy pricing program. In one embodiment, given the relatively long length of the first section 132 representing the maximum remaining comfort reduction possible for the first energy pricing program, the first section 132 is shown in red. The second section 134 representing the comfort reduction no longer possible can be shown in a different color (e.g., blue).

Similarly, the display 140 of the second energy pricing program (B) includes the second energy pricing program name (B) 142, the second energy pricing program cost reduction graphical indicator 150, the second energy pricing program comfort reduction graphical indicator 160, and the second energy pricing program centerline 148.

The length from the end 158 of the second energy pricing program cost reduction graphical indicator 150 to the second energy pricing program centerline 148 represents the maximum total cost reduction available if an energy consumer were to participate for the entire length of the second energy pricing program. Since, in this example, the energy consumer is reviewing the second energy pricing program after the start of the program and therefore cannot receive the maximum total cost reduction available, the second energy pricing program cost reduction graphical indicator 150 includes a first section 152 representing the maximum remaining cost reduction available, and a second section 154 representing the cost reduction no longer available. The length from the end 156 of the first section 152 to the second energy pricing program centerline 148 represents the maximum remaining cost reduction available if an energy consumer were to participate for the remaining length of the second energy pricing program. In one embodiment, given the medium length of the first section 152 representing the maximum remaining cost reduction available for the second energy pricing program, the first section 152 is shown in yellow. The second section 154 representing the cost reduction no longer available can be shown in a different color (e.g., blue).

The length from the end 168 of the second energy pricing program comfort reduction graphical indicator 160 to the second energy pricing program centerline 148 represents the maximum total comfort reduction possible if an energy consumer were to participate for the entire length of the second energy pricing program. Since, in this example, the energy consumer is reviewing the second energy pricing program after the start of the program and therefore cannot receive the maximum total comfort reduction possible, the second energy pricing program comfort reduction graphical indicator 160 includes a first section 162 representing the maximum remaining comfort reduction possible, and a second section 164 representing the comfort reduction no longer possible. The length from the end 166 of the first section 162 to the second energy pricing program centerline 148 represents the maximum remaining comfort reduction possible if an energy consumer were to participate for the remaining length of the second energy pricing program. In one embodiment, given the medium length of the first section 162 representing the maximum remaining comfort reduction possible for the second energy pricing program, the first section 162 is shown in yellow. The second section 164 representing the comfort reduction no longer possible can be shown in a different color (e.g., blue).

Likewise, the display 170 of the third energy pricing program (C) includes the third energy pricing program name (C) 172, the third energy pricing program cost reduction graphical indicator 180, the third energy pricing program comfort reduction graphical indicator 190, and the third energy pricing program centerline 178.

The length from the end 188 of the third energy pricing program cost reduction graphical indicator 180 to the third energy pricing program centerline 178 represents the maximum total cost reduction available if an energy consumer were to participate for the entire length of the third energy pricing program. Since, in this example, the energy consumer is reviewing the third energy pricing program after the start of the program and therefore cannot receive the maximum total cost reduction available, the third energy pricing program cost reduction graphical indicator 180 includes a first section 182 representing the maximum remaining cost reduction available, and a second section 184 representing the cost reduction no longer available. The length from the end 186 of the first section 182 to the third energy pricing program centerline 178 represents the maximum remaining cost reduction available if an energy consumer were to participate for the remaining length of the third energy pricing program. In one embodiment, given the relatively short length of the first section 182 representing the maximum remaining cost reduction available for the third energy pricing program, the first section 182 is shown in red. The second section 184 representing the cost reduction no longer available can be shown in a different color (e.g., blue).

The length from the end 198 of the third energy pricing program comfort reduction graphical indicator 190 to the third energy pricing program centerline 178 represents the maximum total comfort reduction possible if an energy consumer were to participate for the entire length of the third energy pricing program. Since, in this example, the energy consumer is reviewing the third energy pricing program after the start of the program and therefore cannot receive the maximum total comfort reduction possible, the third energy pricing program comfort reduction graphical indicator 190 includes a first section 192 representing the maximum remaining comfort reduction possible, and a second section 194 representing the comfort reduction no longer possible. The length from the end 196 of the first section 192 to the third energy pricing program centerline 178 represents the maximum remaining comfort reduction possible if an energy consumer were to participate for the remaining length of the third energy pricing program. In one embodiment, given the relatively short length of the first section 192 representing the maximum remaining comfort reduction possible for the third energy pricing program, the first section 192 is shown in green. The second section 194 representing the comfort reduction no longer possible can be shown in a different color (e.g., blue).

Once presented with the available energy pricing programs user interface screen 100, the energy consumer can compare graphical indicators of the three energy pricing programs and decide which program to choose to enroll in. Rather than initially being presented with the numerous parameters discussed earlier, the energy consumer is presented with the simple graphical indicators (e.g., having different lengths and colors) to choose the most suitable energy pricing program. For example, if the energy consumer is interested in obtaining the most cost reduction and is willing to endure the greatest comfort reduction in exchange for that cost reduction, that energy consumer would be able to easily identify energy pricing program A as the best choice. On the other hand, if the energy consumer was interested in some cost reduction, but was not willing to endure much of a comfort reduction, they the energy consumer could choose energy pricing programs B or C instead. An energy consumer could use a pointing device (e.g., mouse, joystick, touch screen, touch pad, etc.) to select the particular energy pricing program. In this illustrative example, it is assumed that the energy consumer selects the first energy pricing program (A) and that the current date (CD) is Feb. 1, 2013.

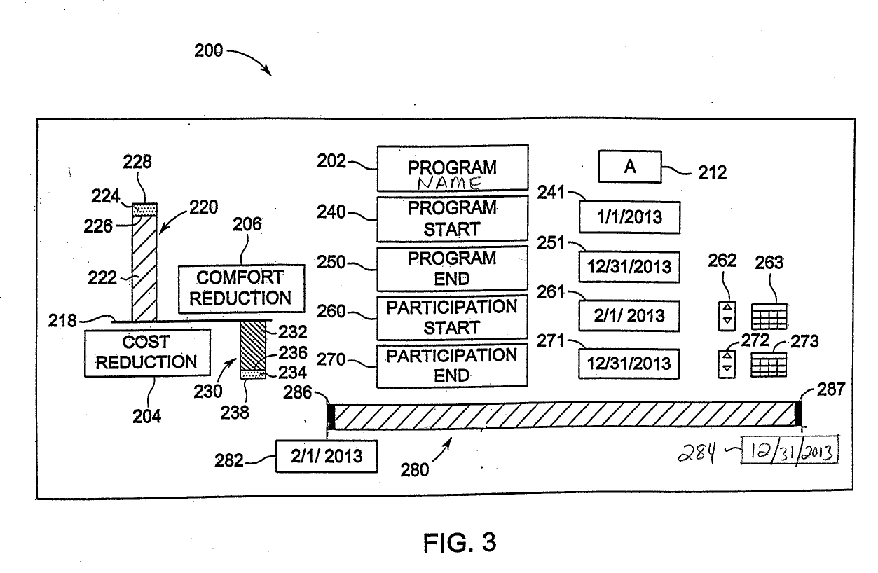

FIG. 3 is an exemplary enrollment user interface screen 200 illustrating the parameters of the first energy pricing program for a first participation period. In one embodiment, after selecting the desired energy pricing program from the available energy pricing programs user interface screen 100, the energy consumer is directed to the enrollment user interface screen 200 to select the program participation start date (PPSD) and the program participation end date (PPED). The exemplary enrollment user interface screen 200 can include a program name graphical label 202, cost reduction graphical label 204, comfort reduction graphical label 206, program start graphical label 240, program end graphical label 250, participation start graphical label 260, and participation end graphical label 270, as well as the program name 212 (e.g., A), program start date 241 (e.g., Jan. 1, 2013), program end date 251 (e.g., Dec. 31, 2013), participation start date 261 (e.g., Feb. 1, 2013), and participation end date 271 (e.g., Dec. 31, 2013). The participation start date 261 can be selected with a pointing device using the date adjustment arrows 262 or by selecting the date on a calendar 263. Similarly, the participation end date 271 is adjustable via date adjustment arrows 272 or by selecting the date on a calendar 273.

The exemplary enrollment user interface screen 200 can also include a participation graphical indicator 280 (e.g., a bar) that includes the current date 282 (e.g., Feb. 1, 2013) and the program end date 284 (e.g., Dec. 31, 2013) at its ends. The participation graphical indicator 280 can also include a participation start date graphical indicator 286 and a participation end date graphical indicator 287, which can be either based on the selection of the dates elsewhere on the enrollment user interface screen 200 (e.g., using the date adjustment arrows 262, 272 or calendars 263, 273) or can also be moved by a pointing device to the desired dates. In the exemplary enrollment user interface screen 200 of FIG. 3, the first participation period has a participation start date of Feb. 1, 2013 (the current date) and a participation end date of Dec. 31, 2013 (the program end date), effectively enrolling in the entirety of the remainder of the energy pricing program.

The exemplary enrollment user interface screen 200 can also include a participation period cost reduction graphical indicator 220, a participation period comfort reduction graphical indicator 230, and a participation period centerline 218. The length from the end 228 of the participation period cost reduction graphical indicator 220 to the participation period centerline 218 represents the maximum total cost reduction available if an energy consumer were to participate for the entire length of the first energy pricing program period. Since, in this example, the energy consumer is selecting the participation period after the start of the program and therefore cannot receive the maximum total cost reduction available, the participation period cost reduction graphical indicator 220 includes a first section 222 representing the participation period cost reduction available in the selected participation period, and a second section 224 representing the cost reduction not available in the selected participation period. The length from the end 226 of the first section 222 to the participation period centerline 218 represents the cost reduction available to the energy consumer based on the selected participation period. In one embodiment, given the relatively long length of the first section 222 representing cost reduction available for the selected participation period (eleven months), the first section 222 is shown in green. The second section 224 representing the cost reduction not available in the selected participation period can be shown in a different color (e.g., blue).

The length from the end 238 of the participation period comfort reduction graphical indicator 230 to the participation period centerline 218 represents the maximum total comfort reduction possible if an energy consumer were to participate for the entire length of the participation period. Since, in this example, the energy consumer is selecting the participation period after the start of the program and therefore cannot receive the maximum total comfort reduction possible, the participation period comfort reduction graphical indicator 230 includes a first section 232 representing the participation period comfort reduction possible in the selected participation period, and a second section 234 representing the comfort reduction not possible in the selected participation period. The length from the end 236 of the first section 232 to the participation period centerline 218 represents the comfort reduction possible to the energy consumer based on the selected participation period. In one embodiment, given the relatively long length of the first section 232 representing comfort reduction possible for the selected participation period, the first section 232 is shown in red. The second section 234 representing the comfort reduction not possible in the selected participation period can be shown in a different color (e.g., blue).

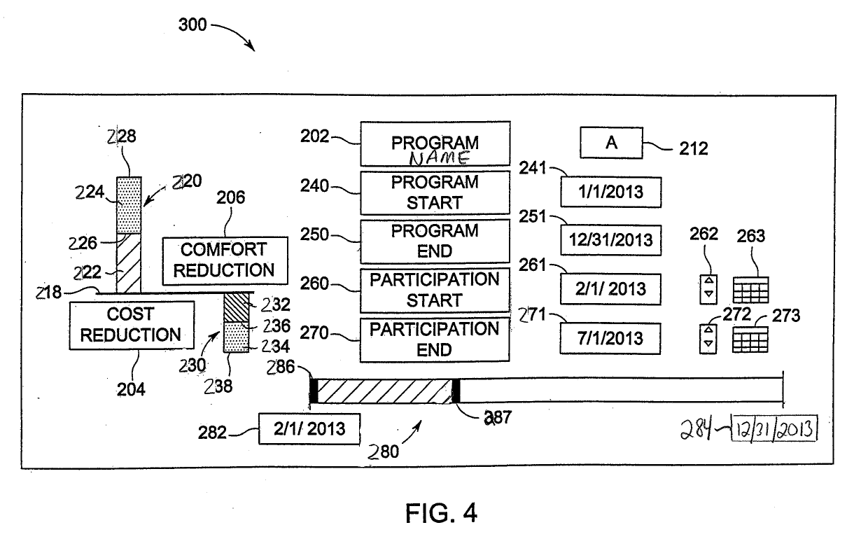

FIG. 4 is an exemplary enrollment user interface screen 300 illustrating the parameters of the first energy pricing program for a second participation period (Feb. 1, 2013 to Jul. 1, 2013—five months), which is shorter than the first participation period (eleven months). Since the second participation period (FIG. 4) is shorter than the first participation period (FIG. 3), the participation graphical indicator 280 for the second participation period is shorter. In addition, the first section 222 of the participation period cost reduction graphical indicator 220, which represents the participation period cost reduction available in the selected participation period, is also shorter. In one embodiment, given the medium length of the first section 222 representing cost reduction available for the selected participation period (five months), the first section 222 is shown in yellow. Similarly, the first section 232 of the participation period comfort reduction graphical indicator 230, which represents the participation period comfort reduction possible in the selected participation period, is also shorter. In one embodiment, given the medium length of the first section 232 representing comfort reduction possible for the selected participation period, the first section is shown in yellow.

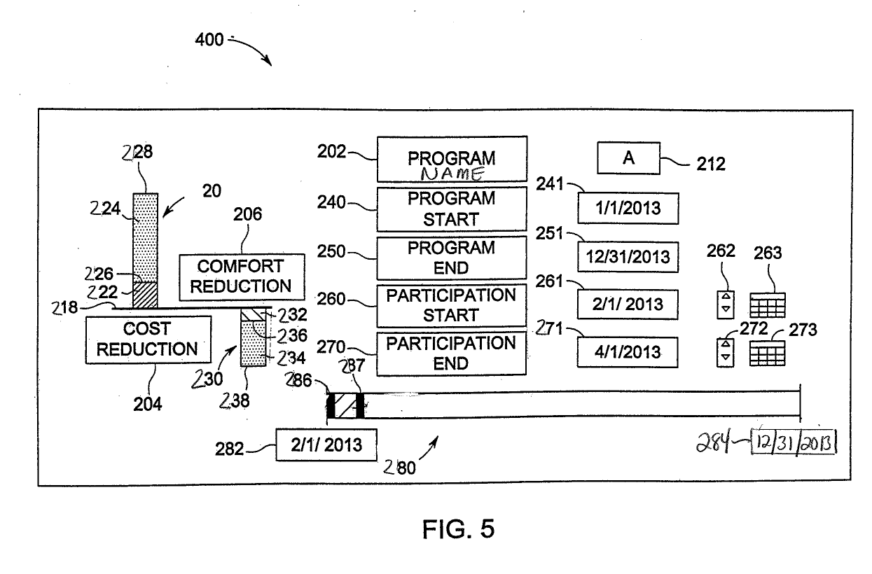

FIG. 5 is an exemplary enrollment user interface screen 300 illustrating the parameters of the first energy pricing program for a third participation period (Feb. 1, 2013 to Apr. 1, 2013—two months), which is shorter than the first participation period (eleven months) and the second participation period (five months). Since the third participation period (FIG. 5) is shorter than the first participation period (FIG. 3) and the second participation period (FIG. 4), the participation graphical indicator 280 for the third participation period is shorter. In addition, the first section 222 of the participation period cost reduction graphical indicator 220, which represents the participation period cost reduction available in the selected participation period, is also shorter. In one embodiment, given the relatively short length of the first section 222 representing cost reduction available for the selected participation period (two months), the first section 222 is shown in red. Similarly, the first section 232 of the participation period comfort reduction graphical indicator 230, which represents the participation period comfort reduction possible in the selected participation period, is also shorter. In one embodiment, given the short length of the first section 232 representing comfort reduction possible for the selected participation period, the first section 232 is shown in green. As can be seen in FIGS. 3 through 5, by adjusting the participation period, the energy consumer can customize the selected energy pricing program to provide the desired cost reduction and acceptable comfort reduction.

In one embodiment, the appearance of the cost reduction and comfort reduction graphical indicators for an energy pricing program are determined based on values calculated based on the parameters for that program (e.g., program type (PT), annual discount (AD), program start date (PSD), program end date (PED), current date (CD), maximum number of events per year (MEY), event duration (ED), standard price (SP), program participation start date (PPSD), program participation end date (PPED), etc.). For example, the program cost reduction value can be calculated for the entire duration of the program, the remaining cost reduction value can be calculated for the cost reduction for the remaining days in the program, and the participation cost reduction value can be calculated for the cost reduction for the participation period of the program selected by an energy consumer. Similarly, the program comfort reduction value can be calculated for the entire duration of the program, the remaining comfort reduction value can be calculated for the comfort reduction for the remaining days in the program, and the participation comfort reduction value can be calculated for the comfort reduction for the participation period of the program selected by an energy consumer. It will be understood that numerous methods can be used to determine a cost reduction value or a comfort reduction value.

In one embodiment, the values can be calculate as follows, where the comfort reduction value is determined as the number of hours of inconvenience caused by enrolling in the program.

Program Days=PED−PSD (1)

Remaining Days=PED−CD (2)

Participation Days=PPED−PPS (3)

Comfort Reduction=(MEY/365)*Days*ED (4)

Cost Reduction=(SP*Comfort Reduction)+AD*(Days/365) (5)

where
Days=Program Days or Remaining Days or Participation Days depending on which comfort reduction or cost reduction value is to be determined.

In view of the foregoing, embodiments of the invention provide user interface screens that allow an energy user to select energy pricing programs and the participation dates in those programs. A technical effect is to allow an energy consumer to more easily understand and then enroll in one or more of the energy pricing programs.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “service,” “circuit,” “circuitry,” “module,” and/or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code and/or executable instructions embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for offering energy pricing programs, the method comprising the steps of:
displaying a user interface screen comprising a display of a first energy pricing program and a second energy pricing program;
displaying a first graphical representation of at least one cost reduction value for the first energy pricing program and a second graphical representation of at least one comfort reduction value for the first energy pricing program; and
displaying a first graphical representation of at least one cost reduction value for the second energy pricing program and a second graphical representation of at least one comfort reduction value for the second energy pricing program.

2. The method of claim 1 further comprising the steps of:
determining at least one cost reduction value for the first energy pricing program and at least one comfort reduction value for the first energy pricing program; and
determining at least one cost reduction value for the second energy pricing program and at least one comfort reduction value for the second energy pricing program.

3. The method of claim 2, wherein the at least one cost reduction value and the at least one comfort reduction value are determined based on the number of days remaining in the first energy pricing program.

4. The method of claim 2, wherein the at least one cost reduction value and the at least one comfort reduction value are determined based on the total number of days in the first energy pricing program.

5. The method of claim 1, wherein the color of the first graphical representation of the at least one cost reduction value for the first energy pricing program is based on the at least one cost reduction value, and the color of the second graphical representation of the at least one comfort reduction value for the first energy pricing program is based on the at least one comfort reduction value.

6. The method of claim 1, wherein the size of the first graphical representation of the at least one cost reduction value for the first energy pricing program is based on the at least one cost reduction value, and the size of the second graphical representation of the at least one comfort reduction value for the first energy pricing program is based on the at least one comfort reduction value.

7. The method of claim 1, wherein the first graphical representation of the at least one cost reduction value for the first energy pricing program is proximate to the second graphical representation of the at least one comfort reduction value for the first energy pricing program.

8. The method of claim 1, wherein the first graphical representation of the at least one cost reduction value for the first energy pricing program is proximate to the first graphical representation of the at least one cost reduction value for the second energy pricing program.

9. The method of claim 1, wherein the second graphical representation of the at least one comfort reduction value for the first energy pricing program is proximate to the second graphical representation of the at least one comfort reduction value for the second energy pricing program.

10. The method of claim 1, wherein the first graphical representation of the at least one cost reduction value for the first energy pricing program is aligned with the second graphical representation of the at least one comfort reduction value for the first energy pricing program.

11. The method of claim 1, wherein the first graphical representation of the at least one cost reduction value for the first energy pricing program is aligned with the first graphical representation of the at least the one cost reduction value for the second energy pricing program.

12. The method of claim 1, wherein the second graphical representation of the at least one comfort reduction value for the first energy pricing program is aligned with the second graphical representation of the at least one comfort reduction value for the second energy pricing program.

13. The method of claim 1, wherein the first graphical representation of the at least one cost reduction value for the first energy pricing program and the second graphical representation of the at least one comfort reduction value for the first energy pricing program are bars.

14. The method of claim 13, wherein the first graphical representation of the at least one cost reduction value for the second energy pricing program and the second graphical representation of the at least one comfort reduction value for the second energy pricing program are bars.

15. A method for offering energy pricing programs, the method comprising the steps of:
determining at least one cost reduction value for the first energy pricing program and at least one comfort reduction value for the first energy pricing program;
determining at least one cost reduction value for the second energy pricing program and at least one comfort reduction value for the second energy pricing program;
displaying a user interface screen comprising a display of a first energy pricing program and a second energy pricing program;
displaying a first graphical representation of at least one cost reduction value for the first energy pricing program and a second graphical representation of at least one comfort reduction value for the first energy pricing program; and
displaying a first graphical representation of at least one cost reduction value for the second energy pricing program and a second graphical representation of at least one comfort reduction value for the second energy pricing program,
wherein the color of the first graphical representation of the at least one cost reduction value for the first energy pricing program is based on the at least one cost reduction value, and the color of the second graphical representation of the at least one comfort reduction value for the first energy pricing program is based on the at least one comfort reduction value, and
wherein the size of the first graphical representation of the at least one cost reduction value for the first energy pricing program is based on the at least one cost reduction value, and the size of the second graphical representation of the at least one comfort reduction value for the first energy pricing program is based on the at least one comfort reduction value.

16. The method of claim 15, wherein the at least one cost reduction value and the at least one comfort reduction value are determined based on the number of days remaining in the first energy pricing program.

17. The method of claim 15, wherein the at least one cost reduction value and the at least one comfort reduction value are determined based on the total number of days in the first energy pricing program.

18. The method of claim 15, wherein the first graphical representation of the at least one cost reduction value for the first energy pricing program is proximate to and aligned with the second graphical representation of the at least one comfort reduction value for the first energy pricing program.

19. The method of claim 15, wherein the first graphical representation of the at least one cost reduction value for the first energy pricing program is proximate to and aligned with the first graphical representation of the at least the one cost reduction value for the second energy pricing program.

20. The method of claim 15, wherein the second graphical representation of the at least one comfort reduction value for the first energy pricing program is proximate to and aligned with the second graphical representation of the at least one comfort reduction value for the second energy pricing program.
